(19) United States
(12) Patent Application Publication
(10) Pub. No.: US 2025/0189287 A1
(43) Pub. Date: Jun. 12, 2025

(54) Spindle Wear Gauge Tool

(71) Applicant: Jerry Tucker, Shawnee, OK (US)

(72) Inventor: Jerry Tucker, Shawnee, OK (US)

(21) Appl. No.: 18/954,229

(22) Filed: Nov. 20, 2024

Related U.S. Application Data
(63) Continuation-in-part of application No. 29/920,266, filed on Dec. 8, 2023, now Pat. No. D071752.
(60) Provisional application No. 63/607,817, filed on Dec. 8, 2023.

(51) Int. Cl. G01B 3/34

(52) U.S. Cl. CPC G01B 3/34

(57) ABSTRACT

A spindle wear gauge tool designed to quickly and accurately assess the wear on a spindle journal. The tool comprises an inner spindle opening and an outer spindle opening, each positioned on opposite sides of the tool's body. Both openings are semicircular with slightly angled edges and are milled to specific tolerances to prevent full engagement with unworn spindle journals. The inner spindle opening includes an inner spindle check with engraved “GO” and “NO GO” markings, while the outer spindle opening includes a similar outer spindle check. These features allow mechanics to easily determine if a spindle has worn past a predetermined tolerance by observing the engagement of the spindle with the tool. The tool is constructed from metal and is designed for durability and ease of use in various mechanical environments.

The current application claims a priority to the U.S. Provisional Patent application Ser. No. 63/607,817 filed on Dec. 8, 2023. The current application claims a priority to the U.S. Design patent application Ser. No. 29/920,266 filed on Dec. 8, 2023.

### FIELD OF THE INVENTION

The present invention relates generally to a spindle wear gauge tool. More specifically, the present invention is a device that quickly assesses the amount of wear a spindle journal has received.

### BACKGROUND OF THE INVENTION

Machine spindle wear gauges are precision tools designed for the crucial task of measuring wear on the spindle journals of machinery. These spindle journals are essential components in rotating machinery, and their wear can lead to decreased efficiency and potential failures. The gauge typically provides a means to accurately assess the extent of wear on the spindle journals, often measured in thousandths of an inch or micrometers. The tool allows for non-destructive testing, enabling maintenance personnel to gauge the health of the spindles without disassembling the machinery. By measuring radial and axial wear, maintenance teams can plan interventions effectively, scheduling maintenance or replacements before serious issues arise and minimizing downtime. The wear gauge is user-friendly, facilitating routine monitoring, and may incorporate features for data collection and analysis, contributing to informed decision-making regarding maintenance schedules and machinery reliability. Overall, it plays a crucial role in preventive maintenance, helping extend the life of machinery and ensure optimal performance.

An objective of the present invention is to provide users with a tool that quickly accesses the amount of wear on a machined spindle journal, to help eliminate the inefficiencies and machine failures. The present invention intends to provide users with a device that can partially engage with a spindle journal. In order to accomplish that, a preferred embodiment of the present invention comprises an inner spindle opening and an outer spindle opening. Thus, the present invention is a spindle wear gauge tool that quickly accesses the amount of wear on a machined spindle journal by partially or fully engaging with the part being tested.

### SUMMARY OF THE INVENTION

The present invention is a tool that rotates around a spindle to measure and detect any areas worn beyond the tolerance a gauge is designed for. The present invention seeks to provide users with a device that can slip onto and fully engage with a worn section of a spindle journal to indicate a worn area. In order to accomplish this the present invention comprises an inner spindle opening that checks an inner spindle. Further, the outer spindle opening checks the wear of an outer spindle. Thus, the present invention is a spindle wear gauge tool that quickly accesses the amount of wear on a machined spindle journal by partially or fully engaging with the part being tested.

### BRIEF DESCRIPTION OF THE DRAWINGS

FIG. 1 is a top front perspective view of the present invention.

FIG. 2 is a bottom rear perspective view of the present invention.

FIG. 3 is a front view of the present invention.

FIG. 4 is a rear view of the present invention.

FIG. 5 is a right-side view of the present invention.

FIG. 6 is a left-side view of the present invention.

FIG. 7 is a top view of the present invention.

FIG. 8 is a bottom view of the present invention.

### DETAIL DESCRIPTIONS OF THE INVENTION

All illustrations of the drawings are for the purpose of describing selected versions of the present invention and are not intended to limit the scope of the present invention.

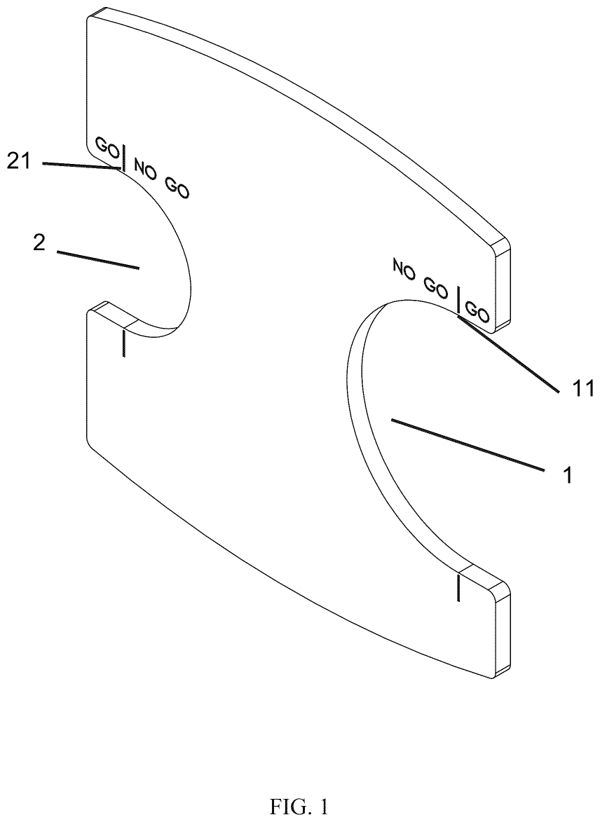

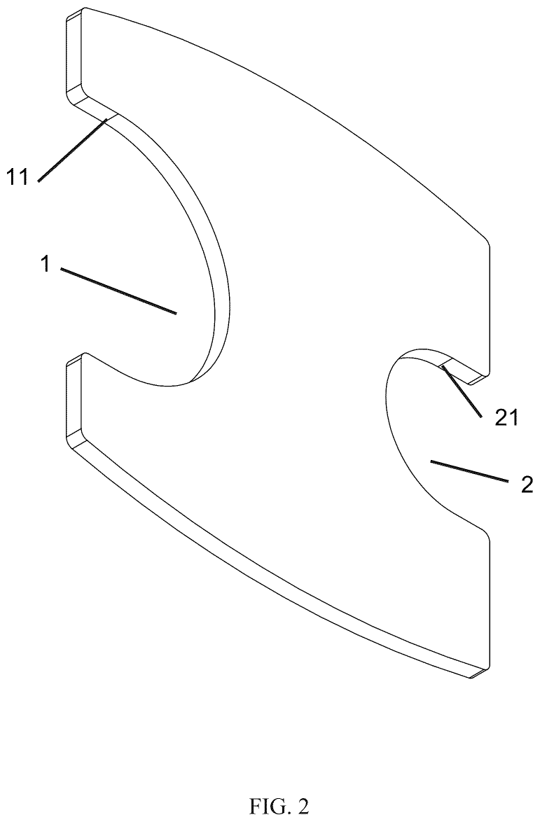

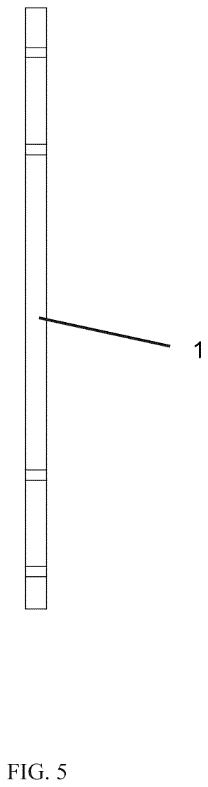

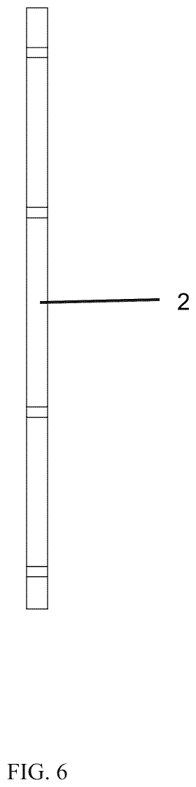

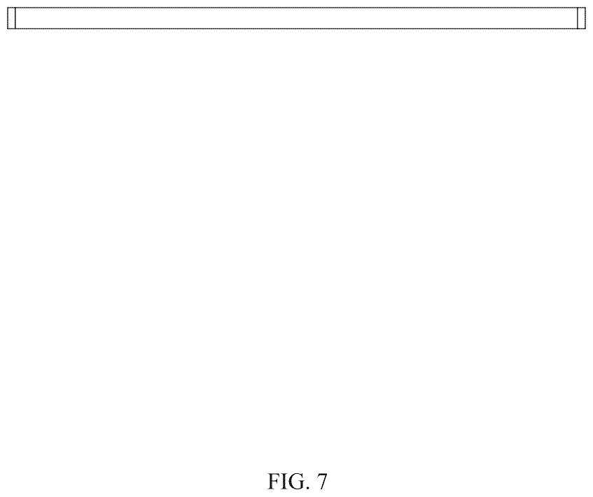

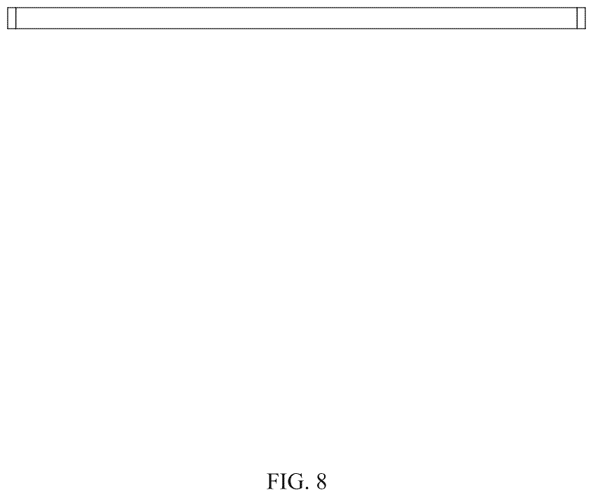

As shown in FIG. 1-8, the present invention is a device that checks a spindle on a spindle rod to check for excessive wear past a predetermined tolerance. An objective of the present invention is to provide users with a device that can quickly determine if a spindle is above or below a tolerance. The present invention intends to provide users with a device that mechanics can quickly utilize to assess a spindle. To accomplish this the present invention comprises an inner spindle opening (1) and an outer spindle opening (2). The inner spindle opening (1) is positioned along the right side of the present invention body while the outer spindle opening (2) is positioned along the left side of the present invention body. Thus, the present invention is a spindle wear gauge tool that quickly accesses the amount of wear on a machined spindle journal by partially or fully engaging with the part being tested.

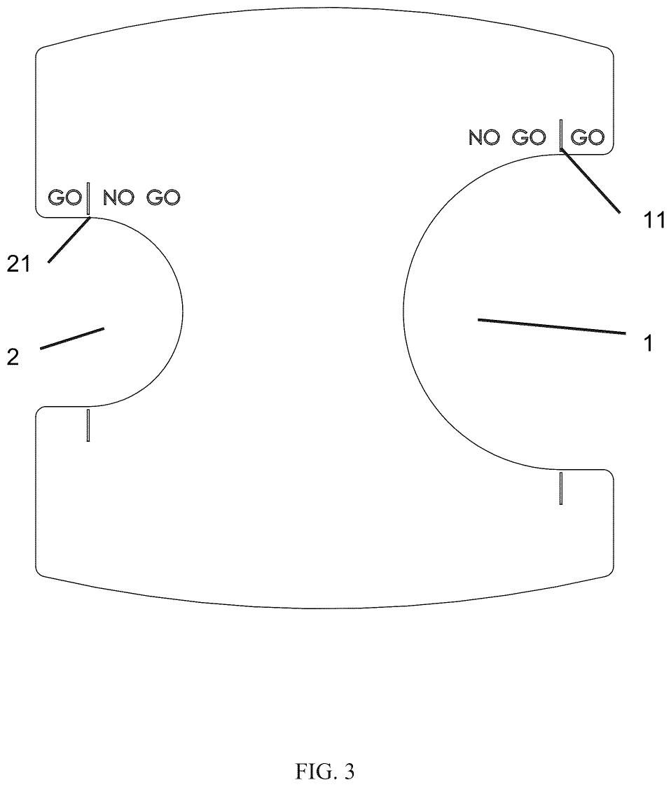

The present invention engages with an inner spindle with the inner spindle opening (1). The inner spindle opening (1) is a semicircular opening with slightly angled edges traversing towards the side of the present invention body as seen in FIG. 3. The present invention body is designed with a metal material. In its preferred embodiment the inner spindle opening (1) is designed to accommodate and test the inner spindle journal of a spindle. The inner spindle opening (1) is milled to a specific tolerance to prevent the inner spindle journal from engaging fully with the inner spindle opening (1) when the spindle is not worn down. The inner spindle opening (1) comprises an inner spindle check (11) as shown in FIG. 1. The inner spindle check (11) is designed with engraved markings starting at the semicircular edge connection to the angled edge. The engraved marking is a dash with the lettering “GO” and “NO GO” on either side of the dash with the “GO” being positioned on the flat side of the inner spindle opening (1) and the “NO GO” being positioned on the semi-circular side of the inner spindle opening (1). This design ensures that as the inner spindle opening (1) is being rotated along a spindle, if the spindle fully engages and touches the edge of the semi-circular surface of the inner spindle opening (1) the user can easily observe the “NO GO” engraved marking and determine the spindle has been worn past the desired tolerance. It should be further noted that the main body material can be created in various ways and the inner spindle opening (1) and inner spindle check (11) can be designed with various sizes and lettering while still staying within the scope of the present invention.

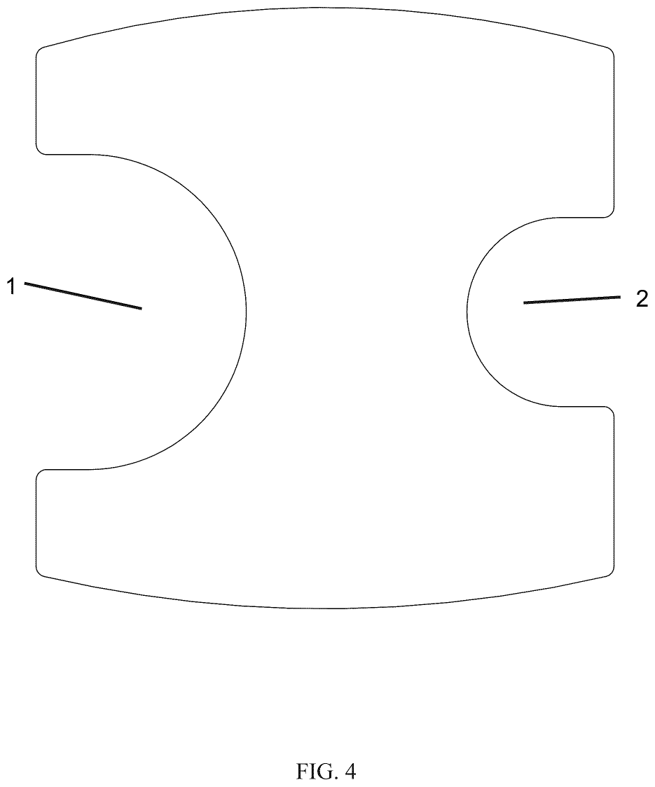

The present invention engages with an outer spindle with the outer spindle opening (2). The outer spindle opening (2) is a semicircular opening with slightly angled edges traversing towards the side of the present invention body as seen in FIG. 4. In its preferred embodiment the outer spindle opening (2) is designed to accommodate and test the outer spindle journal of a spindle. The outer spindle opening (2) is milled to a specific tolerance to prevent the outer spindle journal from engaging fully with the outer spindle opening (2) when the spindle is not worn down. The outer spindle opening (2) comprises an outer spindle check (21) as shown in FIG. 3. The outer spindle check (21) is designed with engraved markings starting at the semicircular edge connection to the angled edge. The engraved marking is a dash with the lettering “GO” and “NO GO” on either side of the dash with the “GO” being positioned on the flat side of the outer spindle opening (2) and the “NO GO” being positioned on the semi-circular side of the outer spindle opening (2) similar to the inner spindle check (11) on the inner spindle opening (1). This design ensures that as the outer spindle opening (2) is being rotated along a spindle, if the spindle fully engages and touches the edge of the semi-circular surface of the outer spindle opening (2) the user can easily observe the “NO GO” engraved marking and determine the spindle has been worn past the desired tolerance. If the spindle does not fully engage with the outer spindle opening (2) and only touches the flat angled sides of the outer spindle opening (2) on the side of the “GO” markings the user can easily determine the spindle can still be utilized and is not worn down past the desired tolerance. With all the components working in tandem with each other it can be seen that the present invention is a spindle wear gauge tool that quickly accesses the amount of wear on a machined spindle journal by partially or fully engaging with the part being tested.

Although the invention has been explained in relation to its preferred embodiment, it is to be understood that many other possible modifications and variations can be made without departing from the spirit and scope of the invention.

What is claimed is:

1. A spindle wear gauge tool, comprising,
an inner spindle opening positioned on one side of a body of the tool, the inner spindle opening having a semicircular shape with slightly angled edges;
an outer spindle opening positioned on another side of a body of the tool, the outer spindle opening having a semicircular shape with slightly angled edges;
wherein the inner spindle opening can engage with an inner spindle journal of a spindle to determine wear, and the outer spindle opening can engage with an outer spindle journal of a spindle to determine wear.

2. The spindle wear gauge tool of claim 1, wherein the inner spindle comprises an inner spindle check, said inner spindle check comprising engraved markings indicating whether a spindle journal of a spindle is worn beyond a predetermined tolerance.

3. The spindle wear gauge tool of claim 1, wherein the outer spindle comprises an outer spindle check, said outer spindle check comprising engraved markings indicating whether a spindle journal of a spindle is worn beyond a predetermined tolerance.

4. The inner spindle check of claim 2, wherein the engraved marking on the flat side of the of the inner spindle opening indicates that a spindle journal of a spindle is not worn beyond a predetermined tolerance, and the engraved marking on the semicircular side of the inner spindle opening indicates that a spindle journal of a spindle is worn beyond a predetermined tolerance.

5. The outer spindle check of claim 3, wherein the engraved marking on the flat side of the of the outer spindle opening indicates that a spindle journal of a spindle is not worn beyond a predetermined tolerance, and the engraved marking on the semicircular side of the inner spindle opening indicates that a spindle journal of a spindle is worn beyond a predetermined tolerance.

6. The spindle wear gauge tool of claim 1, wherein the inner spindle opening and the outer spindle opening are milled to specific tolerances to prevent full engagement with a respective spindle journal when a spindle is not worn down.

7. The spindle wear gauge tool of claim 1, wherein the inner spindle opening and the outer spindle opening allow a spindle journal to partially or fully engage with the opening when worn beyond a predetermined tolerance.
